(19) United States
(12) Patent Application Publication
(10) Pub. No.: US 2005/0019952 A1
(43) Pub. Date: Jan. 27, 2005

(54) Method of filling a well in a substrate

(76) Inventor: Robert Moerman, Delfgatw (NL)

Correspondence Address: DARBY & DARBY P.C., P. O. BOX 5257, NEW YORK, NY, 10150-5257, US

(21) Appl. No.: 10/495,833

(22) PCT Filed: Nov. 15, 2002
(86) PCT No.: PCT/NL02/00737

(30) Foreign Application Priority Data
Nov. 16, 2001 (NL) X1019378

(51) Int. Cl. G01N 1/10

(52) U.S. Cl. 436/180

(57) ABSTRACT

The invention relates to a method of filling a well (including a channel) in a substrate. In accordance with the invention liquid is applied on a substrate comprising a well on a position that does not coincide with the well, and the well after filling is sealed with a cover means, wherein liquid is applied on a position between the front of the cover means and the well that is not covered by the cover means, and with the aid of the cover means the liquid is pushed into the well.

The present invention relates to a method of filling a well with a liquid, wherein a liquid is applied on a substrate comprising a well on a position that does not coincide with the well, and the well after filling is sealed with a cover means.

Such a method is generally known for filling micro arrays that are used for various assays, such as enzyme and DNA assays. Because of the small amount of liquid in a well the effect of evaporation is relatively large. In order to prevent evaporation, a cover means such as a cover slip may be placed over the wells.

A problem is that before taking a measurement several operations have to be carried out, e.g. filling a well with a metered amount of liquid, covering the well filled with liquid (all this preferably without developing air bubbles), and starting the measurement. This latter often requires time consuming operations, since for various measuring techniques such as optical measuring techniques there is only little space around a substrate and for this reason it is often impossible to fill the substrate while mounted. In addition, for many assays the reaction will commence as soon as the well is filled with liquid.

It is the object of the invention to provide a method of the kind mentioned in the preamble by which it is possible to commence measuring more quickly.

To this end the method according to the invention is characterized in that
to fill the well, liquid is applied to a first place located between a second place where a front side of the cover means applied on the substrate is situated and the well not covered by the cover means,
the front side of the cover means is moved in the direction of the liquid that was applied and of the well, thereby taking with it the liquid with which the well is being filled, and
after the front side of the cover means has passed the well, the cover means is brought into a third stationary position in order to seal the liquid-filled well.

Surprisingly it is possible to push a liquid to be introduced into a well forward, to fill the wells quickly and to seal them. All this is done with one single operation, which is also favourable for optional (semi-)automated application of the method according to the invention. The present invention makes it possible to carry out a quantitative assay on a sample, without having to accurately pipette the volume of the sample. After filling and covering a well in accordance with the invention, the well contains a precisely known amount of liquid determined by the well's dimensions. By departing from a relatively large volume with relatively small surface, evaporation is reduced. Immediately after the moment a well is filled, it is already sealed by the cover means, so that this also reduces the effect of evaporation. This is clearly different to filling individual wells with sample liquid by means of a pipette, electrospraying and the like. In the present application a well is understood to be any recess in the substrate irrespective of its shape. This definition also includes elongated wells, which may also be referred to as channel. In essence, such channels run parallel with the surface of the substrate.

Preferably a cover means is used having a thickness of at least 0.5 mm, more preferably at least 0.8 mm, and most preferably at least 1.2 mm.

Such a cover means ensures that the liquid is pushed forward effectively. At the same time, the rigidity of the cover means increases with the increasing thickness so that the cover means adheres better to the substrate.

If the liquid is hydrophilic, a cover means is used in accordance with a preferred embodiment, whose side facing away from the substrate near the front of the cover means is hydrophobic and vice versa.

This will help to prevent that part of the liquid moves over the top of the cover means instead of being pushed forward. This embodiment is especially effective if a thin cover means is being used.

According to a preferred embodiment, a cover means is then used whose hydrophilic side facing the substrate possesses at one of its ends a surface with a hydrophobic portion.

The effect of such a surface portion at the end that before sliding is the closest to the well, is that less (aqueous) liquid is necessary to fill the well.

This surface portion may be rendered hydrophobic by, for example, silanisation but also by applying a hydrophobic paste such as silicone grease. Such a grease does not dissolve in the aqueous liquid and has the further advantage that it can contribute to the prevention of evaporation. In addition, it facilitates sliding a cover means over the substrate.

A further problem is that during and after filling the well, reagent or analyte is carried over from one well to the other due to flow or diffusion. Advantageously the well is filled and sealed so quickly that the reagents are unable to escape from the well. Advantageously at least in a third position the cover means is pressed to the substrate with a force of at least 1 kg/cm².

This reduces transfer of liquid or reagents by flow and/or diffusion. It was also shown to be possible to apply such a force, and even a force of 15 kg/cm² during movement from the first position to the third position. This further helps to limit the transfer of liquid or reagents by flow and/or diffusion.

Preferably the cover means used is a cover means of which the edge of the side facing the substrate and the front side of the cover means is rounded off over at least a portion thereof, and the liquid in contact with this rounding off is moved in the direction of the applied liquid and the well, carrying along the liquid with which the well is to be filled.

Such a rounding helps to carry the liquid along and facilitates filling the well. Such a rounding is particularly suitable for cover means wherein the liquid is in contact with the full height (thickness) of the cover means. The edge formed between the side facing away from the substrate and the front side is in such a case preferably substantially straight, that is to say it forms a sharp angle, which due to the effects of cohesion is not readily passed by a liquid.

Advantageously, on a single substrate a first well is filled with a first liquid and a second well with a second liquid, the first liquid and the second liquid are applied on respective non-overlapping first places, and the cover means is provided with an indentation between the non-overlapping first places.

Instead of this or in addition thereto a first well on a single substrate is filled with a first liquid and a second well with a second liquid, the first liquid and the second liquid being applied on respective non-overlapping first places, and at least one organ chosen from i) the upper side of the substrate and ii) the lower side of the cover means between the first non-overlapping places is provided with a raised barrier while the other organ in the same position has a complementary groove in which the barrier can be received, so that when filling the first and second wells, the barrier is slid through the groove.

Both methods allow wells of a substrate to be filled with different liquids.

According to a favourable embodiment, the cover means comprises at least two front sides, at least one front side being formed by a wall of a groove provided at right angles to the direction of movement at the underside of the substrate, and a first well on a single substrate being filled with a first liquid and a second well with a second liquid, the first liquid and the second liquid being applied on respective non-overlapping first places, such that the well of the first liquid and the well of the second liquid are on the second first place, after which the cover means is placed on the substrate and subsequently moved over the substrate in order to fill the first well and the second well.

In this way wells that are substantially in each other's extended direction, can be filled simultaneously with different liquids.

In order to effectively seal a well after the cover means has been moved to the third position, it is preferred for both the substrate and the cover means to be provided with functional groups capable of forming a physical or chemical bond with the functional groups with which they are in contact.

For example, one component may be provided with amino groups and the other with epoxy groups. Various functional groups can be found quite easily in the literature relating to immobilisation of proteins and other molecules on a surface, therefore the ordinary person skilled in the art requires no further explanation.

The invention also relates to a cover means for the application of the method according to one of the claims 11 to 14, as well as a substrate for the application of the method according to one of the claims 11 to 14.

The present invention will now be elucidated with reference to an explanatory embodiment and the drawing, in which

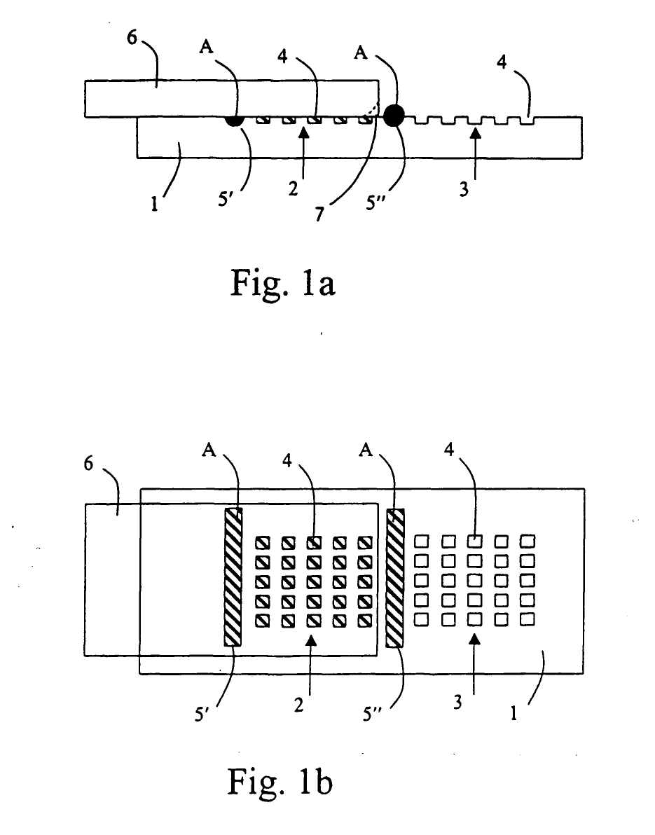

FIGS. 1a and 1b respectively show a side view of a substrate with cover means according to the invention, and a top view of the cover means and substrate;

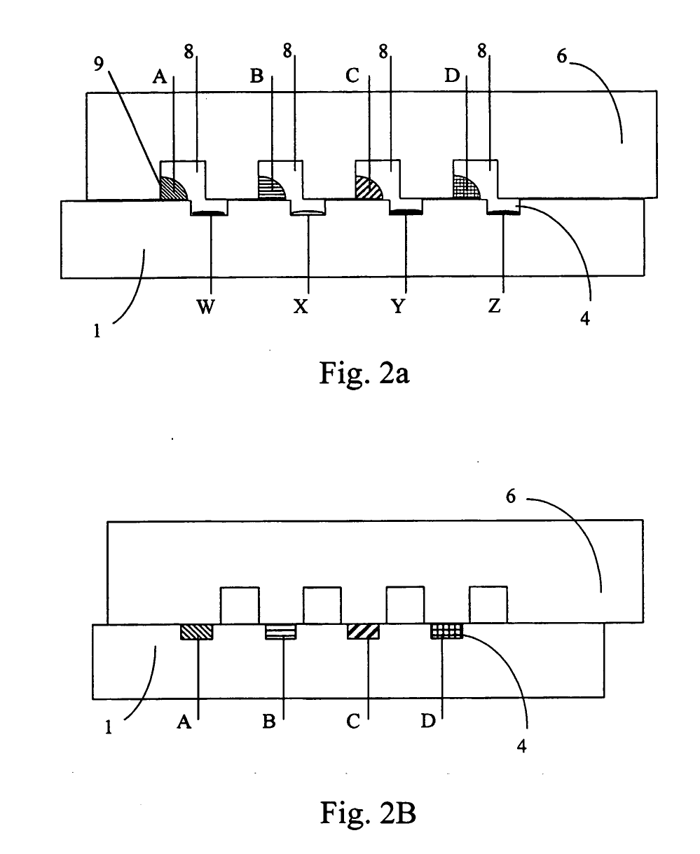

FIGS. 2a and b show a cross-sectional side view of a substrate with cover means according to the invention for the application of different liquids in different wells (before and after); and

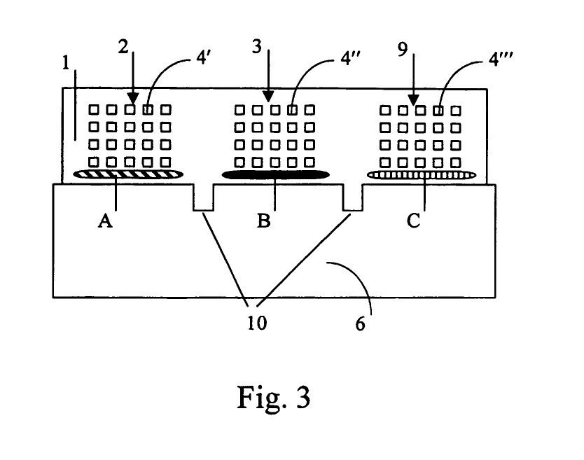

FIG. 3 shows a top view of a substrate with cover means according to the invention.

FIG. 1 shows a substrate 1 provided with two arrays 2, 3, which arrays-2, 3 consist of wells 4. The substrate 1 is also provided with two grooves 5′, 5″, which like the wells 4 have conveniently been provided in the substrate 1 by means of etching. In accordance with one possible embodiment of the invention, the grooves 5′, 5″ are suitable for introducing liquid A into the wells 4. Instead of that, or in addition thereto, it is possible in accordance with an alternative embodiment to provide a linear coating, e.g. a hydrophilic coating having a greater affinity for the liquid. Instead of that, this place may be delimited by two lines of coating for which the liquid has less affinity. In the case of an aqueous liquid being applied it is possible, for example, to use Teflon spray. This may be done quite easily by protecting the place where the liquid is to be applied by means of, for example, a rectangular piece of paper. After the liquid A has been applied, a cover means 6 positioned on the substrate is moved in the direction of the wells. In FIG. 1 the wells 4 of array 2 are already filled.

The side of the cover means 6 facing the substrate and the side of the substrate 1 facing the cover means 6 are completely smooth so that once laid on the substrate, the cover means 6 is equidistantly moveable in relation to the substrate 1, and the sample liquid A can be pushed from the grooves 5′, 5″ into the wells 4. After that the filled wells 4 are immediately sealed by the cover means 6. The surplus liquid A can be blown away with the aid of an air gun (pressure approximately 4-5 bars). Prior to that and preferably during the removal of surplus liquid, a clamping force may be exerted if necessary, which is suitably 2-3 kg/cm². The removal of the liquid ensures that any surface tensional forces do not cause this liquid to be drawn between the cover means 6 and substrate 1, which would increase the thickness of the liquid layer between the cover means 6 and the substrate 1. A very thin liquid layer guarantees that even without a clamping force the cover means will seal the wells 4 by means of adhesion for a measuring time of, for example, 5-20 minutes. For the performance of measurements, the wells 4 may contain reagents that may dissolve in the liquid A with which the wells have been filled. The presence of a thin layer of liquid minimises the exchange (by diffusion) of any possibly present reagent from one well to an adjacent well. Finally, evaporation of a liquid during measurement is effectively avoided with the method described.

The cover means 6 and the substrate 1 are also clean (free of dust) and, in the case of aqueous liquids A, preferably at least on the sides of the substrate 1 and cover means 6 facing each other, hydrophilic. Nevertheless, in the case of aqueous liquids A the end of the side of the cover means 6 facing the substrate 1 is in accordance with a preferred embodiment close to the wells 4 hydrophobic. In this way it can be prevented that relatively much liquid sample A is required for filling the wells 4. According to a simple embodiment, the end of the side facing the substrate 1 is made hydrophobic with the aid of silicone grease. The amount of silicone grease used is kept to a minimum (i.e. a very thin coating is applied). The use of a groove 5 is not a prerequisite and may even be undesirable. The liquid A is preferably applied to the frontal side of the cover means 6, oriented toward to the wells 4. In this way it is still possible to spread the liquid A transversely. Said frontal side is preferably hydrophilic.

The rate at which the cover means 6 is to be moved in relation to the substrate 1 depends on the materials used and on the liquid A used as well as the components, such as surfactants, comprised therein. Nonetheless, a person skilled in the art can easily determine a suitable rate. If the percentage of wells 4 comprising entrapped air is higher than desirable, the rate must be reduced or wells with a rounded or less steep wall must be used (these fill more easily). The substrate 1 and the cover means 6 may be manufactured from any material that is essentially inert (in relation to the liquid A), such as polystyrene, glass or materials that can be treated using techniques known from the semiconductor industry.

Near the substrate side at the front end, the cover means 6 possesses an edge 7, which is preferably provided with a rounding (indicated by the dotted line). This allows the wells 4 to be effectively filled with liquid. A practical method of filling wells is performed as follows:
1) A Pyrex glass (1×0.8 cm) having a thickness of 1 mm is cleaned by treating it with a detergent and rinsing well with demineralised water.

2) The Pyrex glass is placed on a semiconductor substrate. The semiconductor substrate is provided with a hydrophilic SiO₂- and preferably a silicon nitride layer. The semiconductor substrate is provided with wells of 400×400 μm having a depth of 50 μm.
3) By means of capillary action 0.1 to 0.2 μl water is introduced between the Pyrex cover glass and the substrate. The presence of such a minimal amount of liquid causes the Pyrex cover glass to adhere to the substrate by means of suction. It is difficult to remove but can slide.
4) A sample liquid (1 μl) is pipetted in front of a row of wells at a distance from the Pyrex cover glass.

5) The Pyrex cover glass is pushed into the direction of the sample liquid and the wells at a rate of 2-6 cm/s.
6) The cover glass is pressed onto the substrate with a force of 2-3 kg/cm² and surplus sample liquid is blown away with the aid of an air gun (pressure 4 bars).
7) The substrate with cover glass are placed in a slide object holder on an X-Y-Z-table under an objective lens.

In an experiment an array of 5×5 wells of 400×400×50 μm (total volume 0.2 μl) was filled using only 0.5 μl liquid.

Experiments (colour reactions in which the wells were coated with an enzyme) showed that carry-over in a direction transversally to the direction of movement of the cover means in relation to the substrate was minimal. There was some detectable carry-over between successive wells in the direction of movement.

The method according to the invention was shown to be suitable for filling wells with a volatile solvent such as ethanol. This allows the method according to the invention to be applied for combinatorial chemistry and potentially dangerous reactions that are safe to be performed on a small scale.

To the ordinary person skilled in the art it will be obvious that it is possible to vary the present method in many ways without departing from the scope of the invention. For example, in particular if a well is relatively deep, it is advantageous to use a cover means 6 that is not straight e.g. a serrated or fluted one, wherein the serrated or fluted recesses take up the liquid and the cover means 6 with the recesses is pushed over the well 4. If an array 2 has to be filled, the position of the recesses is chosen such that they substantially coincide with the centres of the wells. If desired, different recesses may contain different sample liquids so that different sample liquids can be assayed simultaneously.

In order to apply a layer of sealing, hydrophobic paste such as silicone grease in a defined and reproducible manner, use may be made of a spreader that is at least in one place in contact with the substrate while being moved over the substrate in a direction of an excess of paste. The spreader leaves a narrow groove between the substrate and the spreader, which narrow groove (and the angle at which the spreader is moved), determine the thickness of the layer. The spreader may optionally be also provided with a guide member resting against a side of the substrate.

FIG. 2a shows a substrate 1 provided with various wells 4. The cover means 6 is provided with grooves 8, each of which have a front wall 9 pushing the various liquids A, B, C, D forward. When the cover means 6 is in the third position, the wells 4 are sealed. The wells 4 may comprise various reagents W, X, Y, Z.

FIG. 3 shows a top view of three arrays 2, 3, 9 comprised of wells 4′, 4″, 4′″, to be filled with different liquids A, B, C. In order to prevent the liquids that during the movement of the cover means are being spread along the front edge from coming into contact with each other, recesses 9 are provided, so that the liquids are virtually subjected to different cover means 6.

The application of the liquids and the movement of the liquids is preferably automised by means of dispensers and actuators.

1. A method of filling a well with a liquid, wherein a liquid is applied on a substrate comprising a well on a position that does not coincide with the well, and the well after filling is sealed with a cover means, characterised in that
to fill the well, liquid is applied to a first place located between a second place where a front side of the cover means applied on the substrate is situated and the well not covered by the cover means,
the front side of the cover means is moved in the direction of the liquid that was applied and of the well, thereby taking with it the liquid with which the well is being filled, and
after the front side of the cover means has passed the well, the cover means is brought into a third stationary position in order to seal the liquid-filled well.

2. A method according to claim 1, characterised in that a cover means is used having a thickness of at least 0.5 mm, preferably at least 0.8 mm, and most preferably at least 1.2 mm.

3. A method according to claim 1 or 2, characterised in that if the liquid is hydrophilic, a cover means is used, whose side facing away from the substrate near the front of the cover means is hydrophobic and vice versa.

4. A method according to claim 3, characterised in that the cover means at the hydrophilic side facing the substrate possesses at one of its ends a surface with a hydrophobic portion.

5. A method according to claim 4, characterised in that the hydrophobic surface portion comprises a hydrophobic paste.

6. A method according to one of the preceding claims, characterised in that at least in a third position the cover means is pressed to the substrate with a force of at least 1 kg/cm^{2.}

7. A method according to one of the preceding claims, characterised in that the substrate comprises an array of wells, a groove is provided in the substrate with a main directional component being at right angles to the direction of movement of the cover means, and the liquid is introduced into the groove prior to being transferred to the array by the cover means moving over the groove.

8. A method according to one of the preceding claims, characterised in that when the cover means is in the third position, the liquid surrounding the cover means is removed.

9. A method according to claim 8, characterised in that removal occurs by means of compressed gas.

10. A method according to one of the preceding claims, characterised in that the cover means used is a cover means of which the edge of the side facing the substrate and the front side of the cover means is rounded off over at least a portion thereof, and the liquid in contact with this rounding off is moved in the direction of the applied liquid and the well, carrying along the liquid with which the well is to be filled.

11. A method according to one of the preceding claims, characterised in that on a single substrate a first well is filled with a first liquid and a second well with a second liquid, the first liquid and the second liquid are applied on respective non-overlapping first places, and the cover means is provided with a indentation between the non-overlapping first places.

12. A method according to one of the preceding claims, characterised in that a first well on a single substrate is filled with a first liquid and a second well with a second liquid, the first liquid and the second liquid being applied on respective non-overlapping first places, and at least one organ chosen from i) the upper side of the substrate and ii) the lower side of the cover means between the first non-overlapping places is provided with a raised barrier while the other organ in the same position has a complementary groove in which the barrier can be received, so that when filling the first and second wells, the barrier is slid through the groove.

13. A method according to one of the preceding claims, characterised in that the cover means comprises at least two front sides, at least one front side being formed by a wall of a groove provided at right angles to the direction of movement at the underside of the substrate, and a first well on a single substrate being filled with a first liquid and a second well with a second liquid, the first liquid and the second liquid being applied on respective nonoverlapping first places, such that the well of the first liquid and the well of the second liquid are on the second first place, after which the cover means is placed on the substrate and subsequently moved over the substrate in order to fill the first well and the second well.

14. A method according to one of the preceding claims, characterised in that both the substrate and the cover means are provided with functional groups capable of forming a physical or chemical bond with the functional groups with which they are in contact.

15. A cover means to be used with the method according to one of the claims 11 to 14.

16. A substrate to be used with the method according to one of the claims 11 to 14.
